(19) United States
(12) Patent Application Publication
(10) Pub. No.: US 2018/0326361 A1
(43) Pub. Date: Nov. 15, 2018

(54) FILTRATION MATERIAL HAVING ePTFE AND METHOD OF MAKING

(71) Applicant: KYUNG-JU CHOI, Louisville, KY (US)

(72) Inventor: KYUNG-JU CHOI, Louisville, KY (US)

(21) Appl. No.: 15/326,616

(22) PCT Filed: Feb. 8, 2016
(86) PCT No.: PCT/US16/17031

§ 371 Date: Jan. 16, 2017

(51) Int. Cl. B01D 67/00; B01D 71/36; B29C 55/14

(52) U.S. Cl. CPC B01D 67/0027; B01D 71/36; B32B 37/144; B01D 2323/08; B29C 55/143

(57) ABSTRACT

Disclosed herein is filtration material having expanded polytetrafluoroethylene (ePTFE) and method of making. The method comprises expanding polytetrafluoroethylene in a machine direction orienter (MDO) and expanding or stretching to a ratio from about 20:1 up to about 100:1. The sheet of polytetrafluoroethylene is then relaxed. Upon relaxing the sheet of polytetrafluoroethylene, the sheet of polytetrafluoroethylene is fed into a transverse direction orienter (TDO). The temperature of the sheet of polytetrafluoroethylene in TDO is maintained to remain below 200° C. The sheet of polytetrafluoroethylene is then expanded or stretched to a ratio from about 1.5:1 up to about 100:1, with the TDO, thus providing the expanded polytetrafluoroethylene of the present disclosure having increased tensile strength and finer filaments.

### CROSS-REFERENCE TO RELATED APPLICATION

This patent application is a U.S. National Phase Application under 35 U.S.C. § 371 of International Application No. PCT/US2016/17031, filed Feb. 8, 2016, entitled Filtration Material Having ePTFE and Method of Making, the entire disclosure of which is incorporated herein by reference.

### FIELD OF THE DISCLOSURE

This invention relates to filtration material having expanded polytetrafluoroethylene (ePTFE) and method of making.

### BACKGROUND

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Expanded polytetrafluoroethylene (ePTFE) has recently become a popular filtration media because of its nano-sized filaments (30 to 200 nanometers), hydrophobicity, chemical and thermal stability, cleanliness, flexibility, flow rates, service life, strong filament structure, low coefficient of friction, dielectric properties and low electro-statically charged. For example, ePTFE may provide for a nano-fibrous media having a higher durability, increased hydrophobicity, better chemical and thermal stability, superior cleanliness, higher flexible, and/or longer service life over none-ePTFE filter materials.

In traditional process for producing ePTFE films, calendared polytetrafluoroethylene (PTFE) tapes are expanded or stretched which may provide a filtration material or media having some desired characteristics.

Various methodologies have been suggested for stretching or expanding PTFE materials such as U.S. Pat. No. 3,953,566, incorporated by reference, which may create a node and fibril microstructure characterized by a series of nodes which are interconnected by mesh fibrils. Such material may be amorphously locked by heating above the melting point of PTFE, typically above 330° C. After amorphous locking of the material, additional stretching may be performed at temperature above the crystalline melt point to create a material with a large plurality of nodes which may be oriented perpendicular to the direction of the expansion. Porosity of the film created in such a methodology may be increased. This may be due to the creation of voids or spaces between polymeric nodes and fibrils which may become more numerous and larger in size after the amorphous locking and stretching steps. The methodology set forth however may require amorphous locking and high temperature treatment of the polymer between and during stretching steps, raising the temperature of the material above the crystalline melt point in order to properly lock the polymeric chains at each method step.

U.S. Pat. No. 5,814,405 incorporated herein by reference, similarly discloses an ePTFE structure resulting in a series of rib like rows and nodes wherein the material may be amorphously locked and stretched after beginning with a highly dense and thickened extruded paste. The stretching of the amorphously locked film may occur at temperatures above the crystalline melt point of PTFE.

High temperature stretching or expanding PTFE of traditional processes may incur higher costs and/or may not provide desired characteristics or properties of the ePTFE film or material.

### SUMMARY

In at least one aspect of the present disclosure, a method for expanding polytetrafluoroethylene comprises providing a sheet of polytetrafluoroethylene. The sheet of polytetrafluoroethylene is fed into a machine direction orienter and expanded or stretched to a ratio from about 20:1 up to about 100:1. The sheet of polytetrafluoroethylene is then relaxed. Upon relaxing the sheet of polytetrafluoroethylene, the sheet of polytetrafluoroethylene is fed into a transverse direction orienter. The transverse direction orienter is configured to expand or stretch the sheet of polytetrafluoroethylene in a direction of about 90°, with respect to the direction of expansion or stretch with the machine direction orienter. The temperature of the sheet of polytetrafluoroethylene in the transverse direction orienter is maintained to remain below 200° C. The sheet of polytetrafluoroethylene is then expanded or stretched to a ratio from about 1.5:1 up to about 100:1, with the transverse direction orienter, thus providing expanded polytetrafluoroethylene.

In another aspect of the present disclosure, expanded polytetrafluoroethylene having at least a 10% increase in tensile strength is provided, as compared expanded polytetrafluoroethylene made at higher temperatures.

### BRIEF DESCRIPTIONS OF THE DRAWINGS

The following FIGs., which are idealized, are not to scale and are intended to be merely illustrative of aspects of the present disclosure and non-limiting. In the drawings, like elements are depicted by like reference numerals. The drawings are briefly described as follows.

FIG. 1 is an SEM photomicrograph of the low temperature transverse direction orienter stretched ePTFE of the present disclosure;

FIG. 2 is an SEM photomicrograph of a conventional high temperature stretched ePTFE;

FIG. 3 is WAXD pinhole pattern of the low temperature transverse direction orienter stretched ePTFE of the present disclosure;

FIG. 4 is WAXD pinhole pattern of a conventional high temperature stretched ePTFE;

FIG. 5 is a WAXD integrated intensity in counts as a function of the diffraction angle, 2θ, of the low temperature transverse direction orienter stretched ePTFE of the present disclosure;

FIG. 6 is a WAXD integrated intensity in counts as a function of the diffraction angle, 2θ, of a conventional high temperature stretched ePTFE;

FIG. 7 is a WAXD integrated intensity comparison of the low temperature transverse direction orienter stretched ePTFE of the present disclosure with a conventional high temperature stretched ePTFE;

FIG. 8 graphically shows the crystallinity, measured by WAXD, comparison of the low temperature transverse direction orienter stretched ePTFE of the present disclosure with a conventional high temperature stretched ePTFE; and

FIG. 9 graphically shows the tensile strength comparison of the low temperature transverse direction orienter stretched ePTFE of the present disclosure with a conventional high temperature stretched ePTFE.

### DETAILED DESCRIPTION

Reference will now be made in detail to the present exemplary embodiments and aspects of the present invention, examples of which are illustrated in the accompanying FIGs. As used herein, the term fluid means gas, liquid, or other flowable material. It is to be understood that the invention is not limited in its application to the method and the arrangement of the various steps set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Additionally, and as described in subsequent paragraphs, the specific configurations described are intended to exemplify embodiments of the invention and that other alternative configurations are possible.

Conventional PTFE stretching may be accomplished by beginning with a fine PTFE powder as is known and adding a lubricant or other material. The lubricant may be Isopar or other lubricant to form a paste which may then be extruded under high pressure. Lubricants may be from about 20 to 30 percent. Under high pressure, the material may be paste extruded at about 230 PSI, or more, and at room temperature or higher to create an extruded or otherwise form a tape of 10 to 300 micrometers in thickness. The lubricant may be subsequently removed by heat. The PTFE film or sheet at initial processing stage of stretching may be about 8 to 10 inches in width and about 200 micrometers in thickness. This PTFE film may be fed directly from the calendaring processing stages to a machine direction orienter (MDO), expander, or stretcher and on to a transverse direction orienter (TDO), expander, or stretcher. Typically, the conventional methods for expanding the PTFE, to make ePTFE, involve expanding at about 300° C., in both the MDO and TDO expanders.

These conventional methods of making ePTFE comprise higher temperature stretching than the presently disclosed ePTFE and method of making. This higher temperature expanding, especially in the TDO, may result in ePTFE lacking in one or more properties. Additionally, the high temperature stretching may be a cost intensive process due to frequent maintenance of the tenter clips in a TDO. Energy cost may be substantially higher than the low temperature stretching method of the present disclosure. Thus, the cost of ePTFE may be minimized with the low temperature stretching or expanding method of the present disclosure.

The ePTFE resulting from the presently disclosed method may be utilized in applications such as filters for use in fluid filtration, such as gas and liquid filtration. For example, the filtration material of the present disclosure may be used in air conditioners, ventilation, vacuum cleaners, air cleaners, semiconductor plant clean rooms, dust collection, pharmaceutical manufacturing facilities, food, dairy, beverage, bioprocessing, and the like.

Presently disclosed is filtration material or media having ePTFE and method of making. The method of making ePTFE of the present disclosure comprises multi-stage stretching. For example, PTFE may be expanded one or more times in an MDO and in a low-temperature TDO, with relaxation periods therebetween, for production of stretched porous or expanded polytetrafluoroethylene (ePTFE) fibrous materials.

The ePTFE of the present disclosure may have an extended molecular chain orientation, minimal node size, and/or minimized filament sizes. Due to crystallinity of the ePTFE of the present disclosure, some desired properties may be exhibited. For example, mechanical properties such as tensile strength may be dependent on the crystallinity and the level of chain molecular orientation of the ePTFE of the present disclosure may increase its tensile strength.

As is known, MDO or expander utilizes two primary drums, the first drum having a slower circumferential rotational speed than the secondary drum. The PTFE sheet or film is fed over the circumferential surface of the first drum and to the circumferential surface of the second drum thereby performing an expansion of PTFE film in a longitudinal, or machine, direction to form initial stages of the ePTFE film. Subsequent expansion stages of the ePTFE may occur in a longitudinal or machine direction with additional MDO expansions. Adequate relaxation time may be provided between each MDO expansion. The MDO stretching on an MDO expander may be performed in a range of about 150° C.-300° C. Upon stretching the PTFE film in the MDO, the film may then be fed to a TDO machine.

Upon MDO expansion, the PTFE film or tape is then expanded in a TDO machine and expanded in a direction of about 90°, with respect to the direction of expansion or stretch with the machine direction orienter. TDO stretching may be implemented through a tenter stretcher wherein the sheet is placed and held by tenter clips which stretch the web of material transversely in a tenter frame. Such tenter machines typically utilize tenter clips held on an endless traveling carrier in order to provide width wise tension on the material.

The tenter machine may be utilized to provide the transverse direction orienter stretch of the material at a desired temperature or temperature range. For example, the TDO machine may be configured to expand or stretch the sheet of polytetrafluoroethylene in a direction of about 90°, with respect to the direction of expansion or stretch with the MDO, and maintain the temperature of the PTFE film below 200° C.

Presently disclosed is a method for expanding polytetrafluoroethylene. The method may comprise providing a sheet of polytetrafluoroethylene, such as polytetrafluoroethylene film as disclosed above. The provided sheet of polytetrafluoroethylene may then be fed into a machine direction orienter. The sheet of polytetrafluoroethylene may then be stretched or expanded to a ratio from about 20:1 up to about 100:1, with the machine direction orienter. The sheet of polytetrafluoroethylene may then be relaxed. Stretching or expanding, with the machine direction orienter, and relaxing may be performed a plurality of times to obtain a desired stretch ratio.

Upon relaxing the sheet of polytetrafluoroethylene having a desired stretch ratio, the sheet of polytetrafluoroethylene may then be fed into a transverse direction orienter, TDO. The TDO is configured to expand or stretch the sheet of polytetrafluoroethylene in a direction of about 90°, with respect to the direction of expansion or stretch with the machine direction orienter, MDO. The temperature of the sheet of polytetrafluoroethylene in the TDO may be maintained to remain below 200° C. The sheet of polytetrafluoroethylene may then be expanded or stretched to a ratio from about 1.5:1 up to about 100:1, with the TDO, providing the expanded polytetrafluoroethylene of the present disclosure.

In at least one embodiment of the present disclosure, the method for expanding polytetrafluoroethylene comprises maintaining the temperature of the sheet of polytetrafluoroethylene in the transverse direction orienter to remain below 200° C. comprises maintaining the temperature of the sheet of polytetrafluoroethylene to be within a range of about 50° C. to about 200° C.

In at least one other embodiment of the present disclosure, the method for expanding polytetrafluoroethylene comprises maintaining the temperature of the sheet of polytetrafluoroethylene in the transverse direction orienter to be within a range of about 75° C. to about 200° C.

In at least one additional embodiment of the present disclosure, the method for expanding polytetrafluoroethylene comprises maintaining the temperature of the sheet of polytetrafluoroethylene in the transverse direction orienter to be within a range of about 100° C. to about 200° C.

In at least one further embodiment of the present disclosure, the method for expanding polytetrafluoroethylene comprises maintaining the temperature of the sheet of polytetrafluoroethylene in the transverse direction orienter at about 150° C.

In at least one embodiment of the present disclosure, the method for expanding polytetrafluoroethylene comprises expanding or stretching the sheet of polytetrafluoroethylene to a ratio from about 30:1 up to about 80:1, with the machine direction orienter.

In at least one other embodiment of the present disclosure, the method for expanding polytetrafluoroethylene comprises expanding or stretching the sheet of polytetrafluoroethylene to a ratio of about 40:1, with the machine direction orienter.

The method for expanding polytetrafluoroethylene of the present disclosure may further comprise a step of laminating the expanded polytetrafluoroethylene on at least one scrim immediately after the step of expanding or stretching the sheet of polytetrafluoroethylene with the TDO machine to prevent shrinkage or necking. Necking is a mode of tensile deformation where relatively large amounts of strain localize disproportionately in a small region of the material. Necking causes a prominent decrease in local cross-sectional area and may be associated with yielding. For example, if the ePTFE is subjected to progressively increasing tensile force it may reach a tensile stress wherein necking and elongation may occur. In at least one embodiment of the present disclosure, the method for expanding polytetrafluoroethylene of the present disclosure may further comprise laminating both sides of the expanded polytetrafluoroethylene with scrims.

### Example

ePTFE filtration samples were prepared at the different processing temperatures. A first sample was prepared by feeding a sheet of polytetrafluoroethylene into a machine direction orienter and expanding. The sheet of polytetrafluoroethylene was then fed into a transverse direction orienter and expanded in a direction of about 90°, with respect to the direction of expansion or stretch with the machine direction orienter, and the temperature of the sheet of polytetrafluoroethylene in the transverse direction orienter was maintained below 200° C., or proximate 150° C. A second sample was prepared in a like manner as the first sample with the exception that the temperature of the sheet of polytetrafluoroethylene in the transverse direction orienter was maintained at about 250° C. The first and second samples were analyzed and compared.

Specifically, a machine direction stretched PTFE tape was used. The first sample was stretched transversely at the 12:1 ratio at 150° C. and the second sample at 250° C. at the same ratio of 12:1. Scanning Electron Microscopy (SEM) photomicrographs were made for both samples with a PEMTRON SEM. A WAXD (Wide Angle X-ray Diffraction) scan was carried out with PANalytical X-ray Diffraction Equipment on both samples. Tensile strength was measured with a Shimadzu Model AGS-50G on a 7.4 mm width ePTFE of both samples.

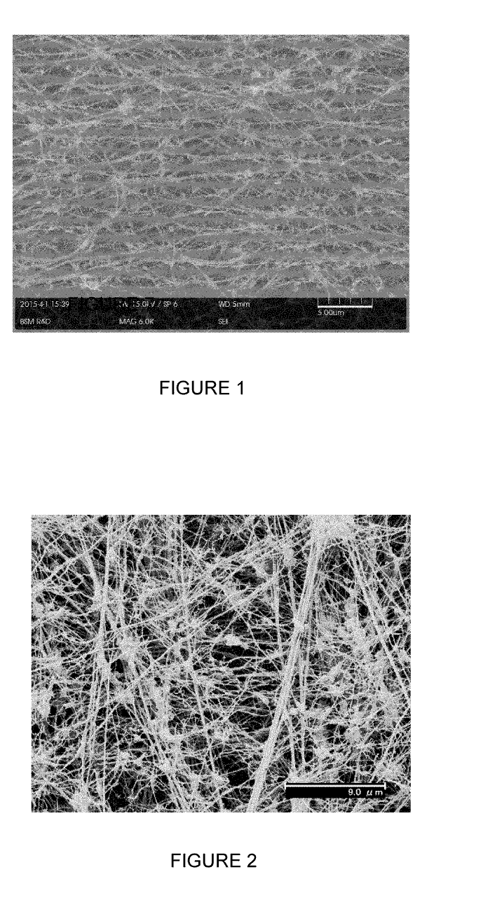

FIG. 1 shows the Scanning Electron Microscopy (SEM) image of the first sample and FIG. 2 shows the Scanning Electron Microscopy (SEM) image of the second sample. A comparison of FIGS. 1 and 2 shows that the first sample, prepared at the low processing temperature, has a much lower node size and much finer filament size than the second sample, prepared at the higher processing temperature.

Since mechanical properties such as tensile strength of semicrystalline polymers (PE, PP, PTFE . . . ) may be dependent on the crystallinity and the level of chain molecular orientation, the chain molecular orientation and crystallinity of these samples were analyzed by means of Wide Angle X-ray Diffraction (WAXD) techniques.

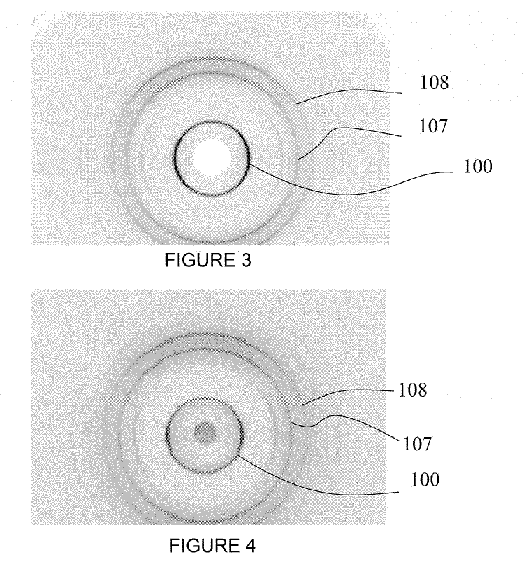

For oriented ePTFE, the crystallographic a and b axes are oriented about 90 degrees away from the stretch direction. Therefore, peaks 100, 107 and 108 may be the more important peaks (reference: Kyung-Ju Choi and J. Spruiell, J. Polym. Science, Part B, 48, 2248-2258 (2010), incorporated herein by reference). The WAXS pinhole patterns are shown in FIG. 3 for the first sample and in FIG. 4 for the second sample.

FIG. 3 shows the crystallographic a, b, and c axes of the ePTFE of the present disclosure having a low temperature TDO stretching. FIG. 4 shows the crystallographic a, b, and c axes of the ePTFE of the prior art having a high temperature TDO stretching. The c axis is the molecular long chain direction. As shown in FIG. 3, peaks 100, 107, and 108 are more pronounced, showing a higher intensity, as compared to FIG. 4. Additionally, the ePTFE of the present disclosure has a substantially lower amorphous halo, as shown in FIG. 3, than the high temperature TDO stretched ePTFE of the prior as shown in FIG. 4. The amorphous halo being shown with the blurring between the peaks or fading of the peaks.

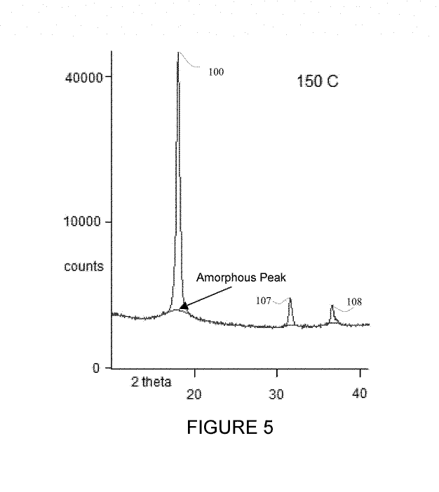

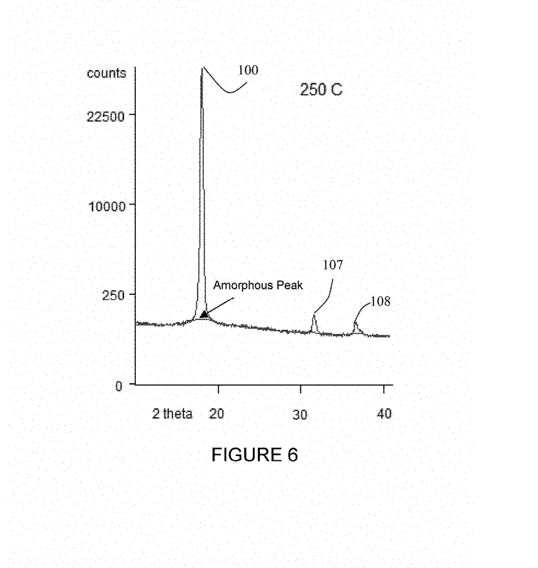

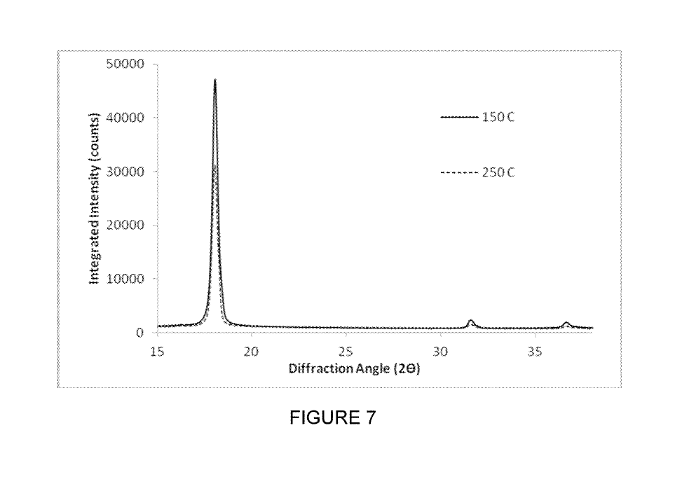

The WAXD integrated intensity of the first sample is shown in FIG. 5 and the WAXD integrated intensity of the second sample is shown in FIG. 6. FIG. 7 shows a WAXD integrated intensity comparison of first and second samples. The WAXD integrated intensities shown in FIGS. 5-7 each include background scattering or the equipment background peak. FIGS. 5-7 graphically show that the molecular chain orientation level of the first sample, having a temperature of about 150° C. in the TDO machine, is higher than that of the second sample, having a temperature of about 250° C. in the TDO machine. Table 1, below shows a numerical comparison of the intensity of the selected crystalline peaks of the first sample and the second sample.

TABLE 1

| | First Sample | Second Sample |
|---|---|---|
| Intensity (counts) | 150° C. | 250° C. |
| (100) peak | 45,358 | 29,869 |
| (107) peak | 882 | 384 |
| (108) peak | 106 | 95 |

The crystallinity of semicrystalline polymers may be measured by X-ray diffraction, DSC, density, IR and NMR. The WAXD method is widely used to estimate the crystallinity of semicrystalline polymers by integrating the relative intensity of the peaks and halos shown below:

Crystallinity=total area of crystalline peaks/total area of all peaks including amorphous halos.

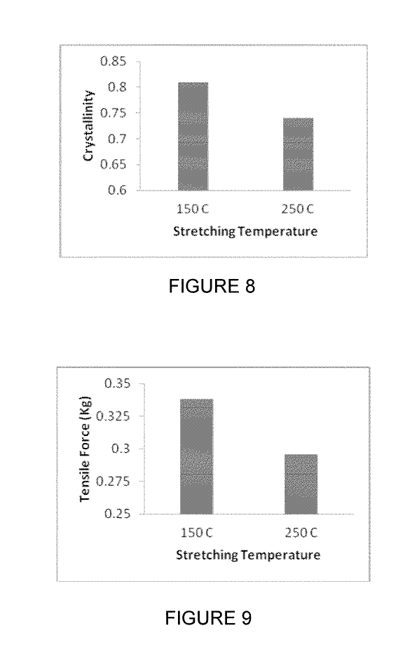

By using FIGS. 5 and 6, the crystallinities of the first and second sample, prepared at 150° C. and at 250° C., were 0.81 and 0.74, respectively. This is shown in FIG. 8.

The tensile strength was measured for the first and second samples and is graphically shown in FIG. 9. The specimen size for each sample was much 7.4 mm×2 micrometers. The tensile forces in Kg of the first sample prepared at TDO 150° C. is shown to be about 0.338 Kg. The tensile forces in Kg of the second sample prepared at TDO 250° C. is shown to be about 0.296 Kg. Therefore, the presently claimed process produces ePTFE having at least a 10% increase, or about a 14% increase, in tensile strength over the ePTFE made with conventional methods.

It is shown that the sample prepared at the lower processing temperature, first sample, has a higher level of chain molecular orientation and crystallinity with better tensile strength than the second sample prepared at higher processing temperature. Additionally, the scanning Electron Microscopy (SEM) images of samples, FIGS. 1 and 2, showed that the first sample prepared at the low processing temperature has a much less node size and a much finer filament size than the second sample prepared the higher processing temperature.

The foregoing description of structures and methods has been presented for purposes of illustration. It is not intended to be exhaustive or to limit the invention to the precise steps and/or forms disclosed, and obviously many modifications and variations are possible in light of the above teaching. It is understood that while certain forms of expansion of PTFE films have been illustrated and described, it is not limited thereto except insofar as such limitations are included in the following claims and allowable functional equivalents thereof.

1. A method for expanding polytetrafluoroethylene comprising the steps of:
providing a sheet of polytetrafluoroethylene;
feeding the sheet of polytetrafluoroethylene into a machine direction orienter;
expanding or stretching the sheet of polytetrafluoroethylene to a ratio from about 20:1 up to about 100:1, with the machine direction orienter;
relaxing the sheet of polytetrafluoroethylene;
upon relaxing the sheet of polytetrafluoroethylene, feeding the sheet of polytetrafluoroethylene into a transverse direction orienter;
wherein, the transverse direction orienter is configured to expand or stretch the sheet of polytetrafluoroethylene in a direction of about 90°, with respect to the direction of expansion or stretch with the machine direction orienter;
maintaining the temperature of the sheet of polytetrafluoroethylene in the transverse direction orienter to remain below 200° C.;
expanding or stretching the sheet of polytetrafluoroethylene to a ratio from about 1.5:1 up to about 100:1, with the transverse direction orienter, and providing expanded polytetrafluoroethylene.

2. The method for expanding polytetrafluoroethylene of claim 1, wherein the step of maintaining the temperature of the sheet of polytetrafluoroethylene in the transverse direction orienter to remain below 200° C. comprises maintaining the temperature of the sheet of polytetrafluoroethylene to be within a range of about 50° C. to about 200° C.

3. The method for expanding polytetrafluoroethylene of claim 2, wherein the step of maintaining the temperature of the sheet of polytetrafluoroethylene in the transverse direction orienter to remain below 200° C. comprises maintaining the temperature of the sheet of polytetrafluoroethylene to be within a range of about 75° C. to about 200° C.

4. The method for expanding polytetrafluoroethylene of claim 1, wherein the step of maintaining the temperature of the sheet of polytetrafluoroethylene in the transverse direction orienter to remain below 200° C. comprises maintaining the temperature of the sheet of polytetrafluoroethylene to be within a range of about 100° C. to about 200° C.

5. The method for expanding polytetrafluoroethylene of claim 4, wherein the step of maintaining the temperature of the sheet of polytetrafluoroethylene in the transverse direction orienter to remain below 200° C. comprises maintaining the temperature of the sheet of polytetrafluoroethylene to be remain at about 150° C.

6. The method for expanding polytetrafluoroethylene of claim 1, wherein the step of expanding or stretching the sheet of polytetrafluoroethylene with the machine direction orienter comprises expanding or stretching the sheet of polytetrafluoroethylene to a ratio from about 30:1 up to about 80:1.

7. The method for expanding polytetrafluoroethylene of claim 6, wherein the step of expanding or stretching the sheet of polytetrafluoroethylene with the machine direction orienter comprises expanding or stretching the sheet of polytetrafluoroethylene to a ratio of about 40:1.

8. The method for expanding polytetrafluoroethylene of claim 1 further comprising a step of laminating the expanded polytetrafluoroethylene on at least one scrim immediately after the step of expanding or stretching the sheet of polytetrafluoroethylene with the transverse direction orienter to prevent necking.

9. The method for expanding polytetrafluoroethylene of claim 8, wherein the step of laminating the expanded polytetrafluoroethylene on at least one scrim comprises laminating both sides of the expanded polytetrafluoroethylene with scrims.

10. The expanded polytetrafluoroethylene made by the method of claim 1 having at least one of a)-c), wherein a)-c) are:
a) a 10% increase in tensile strength as compared to expanded polytetrafluoroethylene made by expanding polytetrafluoroethylene at temperatures greater than 200° C.;
b) a finer filament size as compared to expanded polytetrafluoroethylene made by expanding polytetrafluoroethylene at temperatures greater than 200° C.; and
c) a smaller node size as compared to expanded polytetrafluoroethylene made by expanding polytetrafluoroethylene at temperatures greater than 200° C.

11. The expanded polytetrafluoroethylene made by the method of claim 10 having at least a 10% increase in tensile strength as compared to the methods of expanding polytetrafluoroethylene at temperatures greater than 200° C.

12. The expanded polytetrafluoroethylene made by the method of claim 11 having at least a 14% increase in tensile strength as compared to the methods of expanding polytetrafluoroethylene at temperatures greater than 200° C.
